(19) United States
(12) Patent Application Publication
(10) Pub. No.: US 2015/0331259 A1
(43) Pub. Date: Nov. 19, 2015

(54) Film Laminated Ophthalmic Lenses with Improved Wheel Edging Performance

(71) Applicant: ESSILOR INTERNATIONAL (COMPAGNIE GENERALE D'OPTIQUE), Charenton-le-Pont (FR)

(72) Inventors: Peiqi Jiang, Dallas, TX (US); Steven Weber, Dallas, TX (US); Marvin Pounders, Dallas, TX (US); Jeanne Marchal, Charenton-le-Pont (FR); Montserrat Burgos, Charenton-le-Pont (FR)

(73) Assignee: ESSILOR INTERNATIONAL (COMPAGNIE GENERALE D'OPTIQUE, Charenton-le-Pont (FR)

(21) Appl. No.: 14/655,653

(22) PCT Filed: Dec. 28, 2012
(86) PCT No.: PCT/US2012/072035

§ 371 Date: Jun. 25, 2015

(51) Int. Cl. G02C 7/12; G02C 7/02

(52) U.S. Cl. CPC G02C 7/12; G02C 7/02; G02C 2202/16

(57) ABSTRACT

A laminated optical lens having an edging-optimized laminar configuration and method for manufacturing same. The laminated optical lens includes an optical base lens and a film layered structure including an external film furthest from said lens. An adhesive layered structure is placed between the film layered structure and the optical base lens so as to permanently retain the film layered structure on the surface of the optical base lens. The laminated lens is manufactured by laminating a film layered structure having an external film to an optical base element with an adhesive layered structure. The external film has a thickness of at least 100 μιπ, and preferably a thickness in the range of 150 microns to 300 microns inclusive. The adhesive layered structure has a thickness in the range of 5 microns to 100 microns inclusive, and preferably of 25 microns to 50 microns inclusive

### BACKGROUND OF THE INVENTION

1. Field of the Invention

The present invention relates to film laminated ophthalmic lenses with improved wheel edging performance.

2. The Prior Art

Ophthalmic lenses are manufactured as circular disks. The peripheral edge of the disk is then removed by wheel edging to provide a trimmed lens that will fit into a frame or be used as rimless spectacles. To provide the optical properties of lenses, a film or a film layered structure could be laminated onto the circular disk. For example, a single film or a film layered structure comprising at least one functional film may be laminated to lenses. However, the film and layered structure laminated lenses are delicate components that can easily become delaminated during the wheel edging process.

More specifically, a single layer film 10a or simple film is laminated to a lens 10s with an adhesive layer 10g, as can be seen in FIG. 1A. In other cases a layered structure is provided that includes two or more individual film layers. One example of such film layered structure is a polarizing structure which comprises a polyvinyl alcohol based layer (PVA) sandwiched between two triacetate cellulose films (TAC). The PVA film is laminated between the TAC layers, so that these latter act as protecting layers on both sides of the PVA layer. Such film structure is represented in FIG. 2, which generally refers to FIGS. 2A, 2B and 2C. The film layered structure 20w includes an external TAC film 20a, a first intermediate adhesive layer 20h, an intermediate PVA film 20c, a second intermediate adhesive layer 20d and an inner TAC film 20e. The film layered structure 20w is laminated to a lens 20s with an additional layer of adhesive 20g.

Two types of defects can appear during wheel edging of fragile assembles: either film separation or/and film deformation.

For instance, the failing interface that causes film separation can occur at three different locations. Such failing interface 10x occurs between the lens 10s and the simple film 10a as shown in FIG. 1B. In the case of laminated film layered structure two types of defects may occurs. The first type of defect 20x is inside the film layered structure 20w as shown in FIG. 2B. The second type of defect 20y occurs between the lens and 20s and the film layered structure 20w as shown in FIG. 2C.

Accordingly, it would be desirable to provide single film laminated lenses and film layered structure laminated lenses which exhibit excellent performance during the wheel edging process.

### SUMMARY OF THE INVENTION

Accordingly, it is an object of an embodiment of the present invention to provide film and film layered structure laminated lenses with enhanced mechanical properties.

It is another object to improve wheel edging performance without changing the chemical composition of the adhesive, film, or tens.

It is a further object to specify an assembly configuration with existing materials that resists delamination during wheel edging process.

It is another object to provide a method for configuring a laminated lens that is well suited for wheel edging.

It is a further object to assemble the configuration with existing manufacturing methods without adding steps, time or cost.

These and other related object are achieved according to an embodiment of the invention by a laminated lens adapted for improved wheel edging performance having a film or film layered structure laminated to an ophthalmic lens with adhesive.

The laminated optical lens product has an edging-optimized laminar configuration which includes an optical base lens and a film layered structure including an external film furthest from said lens. An adhesive layered structure is disposed between the film layered structure and the optical base lens so as to permanently retain the film layered structure on the surface of the optical base lens. The external film has a thickness of at least 100 μm, and preferably a thickness in the range of 150 microns to 300 microns inclusive, and preferably a thickness of 190 microns. The adhesive layered structure includes at least one layer of a pressure sensitive adhesive of optical quality, having a thickness in the range of 5 microns to 100 microns inclusive, and preferably of 25 microns to 50 microns inclusive. Alternately, the adhesive layered structure comprises a tri-layer adhesive structure having a thickness in the range of 5 microns to 16 microns inclusive. The tri-layer adhesive structure includes two layers of latex adhesive and one layer of hot melt adhesive sandwiched between the two layers of latex. This invention provides an improved assembly by increasing the thickness of the external film, so the last film layer of the assembly is an optimal thickness without changing the adhesive chemistry.

The film layered structure includes two or more films including the external film, and a proximal film which is in contact with the adhesive layered structure; and optionally an intermediate film sandwiched between the external film and the proximal film. One or more intermediate adhesive layers are disposed between the films. Each intermediate adhesive layer has a thickness above 0.5 microns, preferably in the range of 1.0 microns to 5.0 microns inclusive. The intermediate film is a light-polarizing polyvinyl alcohol-based layer (PVA), and the external and proximal films are triacetyl cellulose-base layers (TAC). The external film is a triacetyl cellulose-base layer (TAC), having a thickness of at least 100 μm, and preferably a thickness in the range of 150 microns to 300 microns inclusive, and preferably a thickness of 190 microns. The film layered structure comprises one triacetyl cellulose-base layer (TAC) which is in contact with the layer of a pressure sensitive adhesive.

According to another aspect of the invention, a method for manufacturing a laminated lens comprising forming an edging-optimized laminated lens. Initially there is provided an optical base lens, an adhesive layered structure, and a film layered structure including an external film. The film layered structure is laminated to the optical base element, with the adhesive layered structure disposed between the film layered structure and the optical base lens so as to permanently retain the film layered structure on the surface of the optical base lens. The external film has a thickness of at least 100 μm, and preferably a thickness in the range of 150 microns to 300 microns inclusive, and preferably a thickness of 190 microns.

The adhesive layered structure includes at least one layer of a pressure sensitive adhesive of optical quality, having a thickness in the range of 5 microns to 100 microns inclusive, and preferably of 25 microns to 50 microns inclusive. Alternatively, the adhesive layered structure includes a tri-layer adhesive structure having a thickness in the range of 5 microns to 16 microns. The tri-layer adhesive structure includes two layers of latex adhesive and one layer of hot melt adhesive sandwiched between the two layers of latex.

The film layered structure includes two or more films including the external film, and a proximal film which is in contact with the adhesive layered structure; and optionally an intermediate film sandwiched between the external film and the proximal film. One or more intermediate adhesive layers are disposed between the films. Each intermediate adhesive layer has a thickness of above 0.5 microns, preferably in the range of 1.0 micron to 5.0 microns inclusive. The intermediate film is a light-polarizing polyvinyl alcohol-based layer (PVA), and the external and proximal films are triacetyl cellulose-base layers (TAC).

The external film is a triacetyl cellulose-base layer (TAC), having a thickness of at least 100 μm, and preferably a thickness in the range of 1150 microns to 300 microns inclusive, and preferably a thickness of 190 microns. The film layered structure includes one triacetyl cellulose-base layer (TAC) which is in contact with the layer of a pressure sensitive adhesive.

### BRIEF DESCRIPTION OF THE DRAWINGS

The advantages, nature, and various additional features of the invention will appear more fully upon consideration of the illustrative embodiments now to be described in detail in connection with accompanying drawings. In the drawings wherein like reference numerals denote similar components throughout the views:

FIG. 1A is a diagram of a prior art single film laminated to a lens.

FIG. 2A is a diagram of a prior art tri-layer structure laminated to a lens.

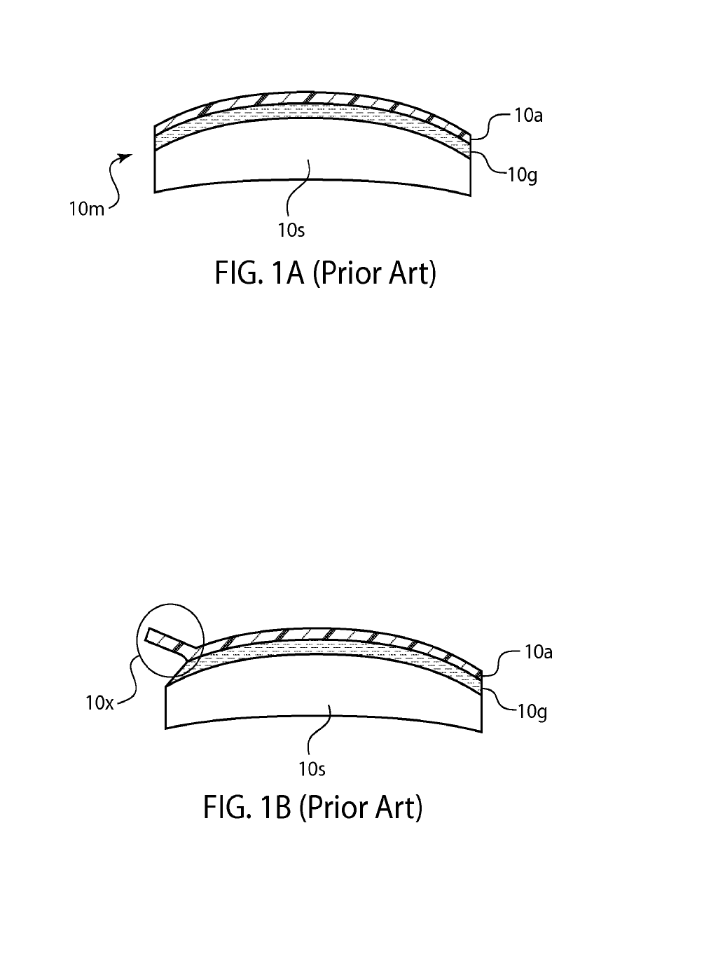

FIG. 1B is a diagram illustrating film-lens delamination.

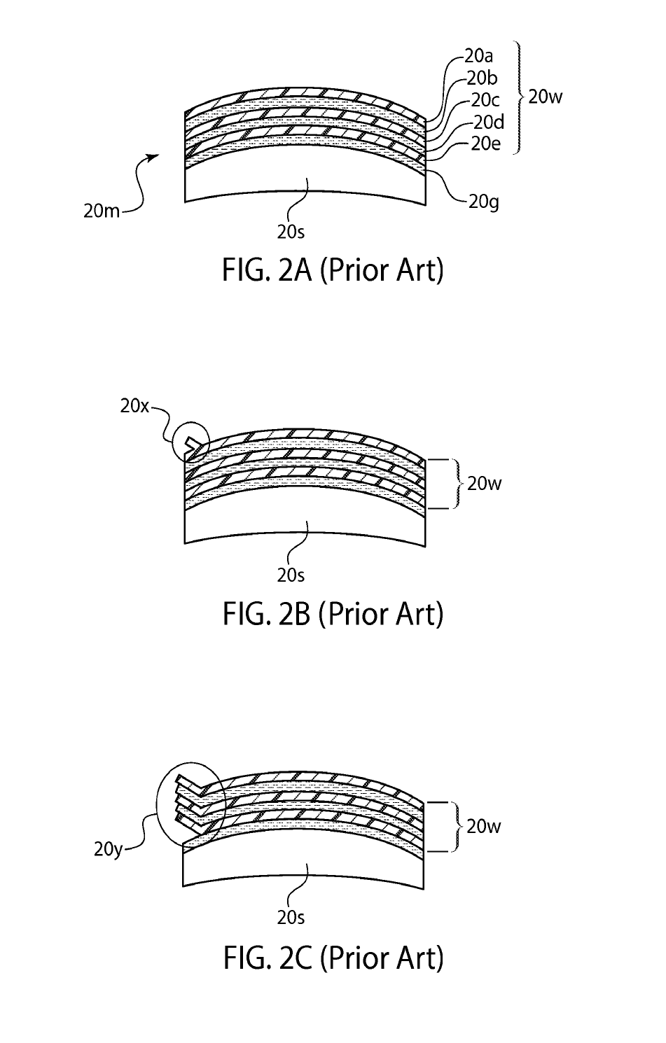

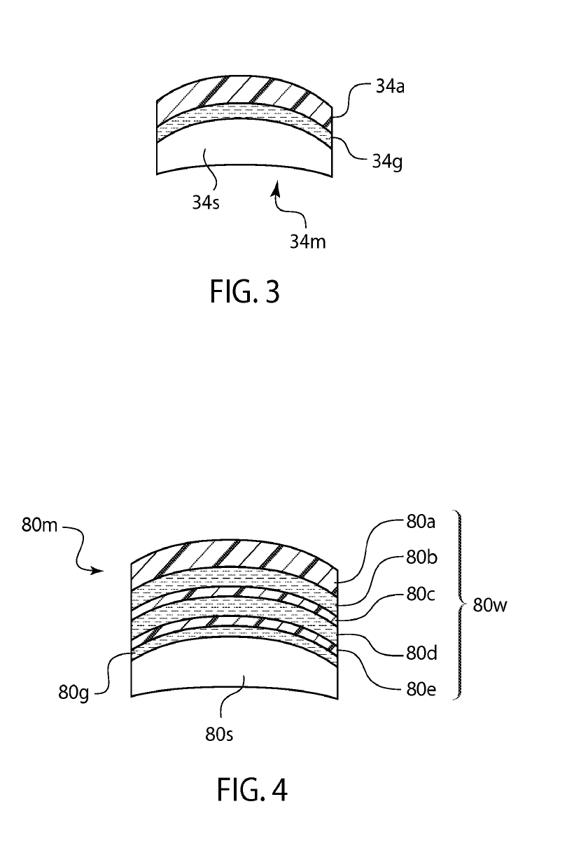

FIG. 2B is a diagram illustrating film-film delamination within the external layers of the structure.

FIG. 2C is a diagram illustrating tri-layer structure-lens delamination.

FIG. 3 is a diagram showing a single film laminated to a lens configuration according to an embodiment of the invention.

FIG. 4 is a diagram showing a tri-layer structure laminated to a lens configuration according to a further embodiment of the invention.

### DETAILED DESCRIPTION OF THE PREFERRED EMBODIMENTS

In this application the following definitions apply to the various words mentioned.

Film refers to single layer of material, for example, a functional film, or a triacetate cellulose or cellulose triacetate film (TAC) film,

Film layered structure refers to a single film of material or a stratified structure comprising two or more individual film layers having identical or different characteristic that are adhered together

Adhesive layer refers the adhesive layer in direct contact with the optical base lens and disposed between the functional film or the film layered structure and the optical base lens in order to obtain a permanent contact between them.

Intermediate adhesive layer refers the adhesive layer disposited between two films in order to obtain a film layered structure.

External film refers the film disposed on the opposite side of the adhesive layer from lens and furthest from the lens. In the case of single film structure, the single film is considered as external film.

Proximal or inner film refers the film in conformal contact with the face of the optical lens.

Polar or polarizing film refers to a film which performs a polarizing function,

HMA means a hot melt adhesive.

PSA means a pressure sensitive adhesive.

PVA refers to a polarized polyvinyl alcohol film, that is, a single film layer.

Polarizing structure refers to a PVA film and a protecting film provided on at least one surface thereof or a tri-layer structure comprising a first protecting film, an intermediate PVA film and a second protecting film.

Rx means a prescription for an ophthalmic lens.

Wheel edging means mechanical shaping of the perimeter of an optical article using a grinding wheel typical in the optical industry without or with water.

In general, the apparatus embodiment of the invention comprises an edging-optimized laminar configuration having an adhesive layer in contact with the tens, and a thicker external film, that is, the film furthest from the lens. The edging-optimized laminar configuration is simple to implement since it utilizes conventional adhesives and films. In the case of film layered structure as polarizing structure, conventional intermediate adhesives can be used, with a thickness adjustment on the external film layer to improve its mechanical properties.

This improvement in mechanical properties is obtained by increasing the thickness of the external film layer. This edging performance is enhanced by increasing the thickness of the external film; the thickness of the adhesive layer and the intermediate adhesive layers within the film layers structure to an optimum combination. Thanks to this combination, standard wheel edging defects are overcome avoiding film deformation and/or film separation.

Simple Single Film Laminate with Improved Edging Performance

FIGS. 1A and 3 are comparative examples of simple film lamination. In FIG. 1A a simple thin TAC film 10a is laminated to a lens 10s by a thin PSA adhesive layer 10g. The film 10a is approximately 40 microns thick and the adhesive layer 10g is 25 microns thick. A laminated lens 10m having these thin layers give poor edging results. In other words, laminated lens 10m will have an unacceptably high percent of defects as shown in FIG. 1B.

In FIG. 3 a simple thick TAC film 34a is laminated to a lens 34s by a thick PSA adhesive layer 34g. The film 34a is approximately 190 microns thick and the adhesive layer 34g is 25 microns thick. A laminated lens 34m having these thick layers gives good edging results. In other words, laminated lens 34m will have a low percent of defects or no defects.

In the case of a simple TAC film glued onto a lens by a PSA, we have undergone a series of experiments. In these experiments we have changed the thickness of the PSA and the thickness of the TAC film. The lenses with the film have been edged and then we have analysed the number of lenses presenting film separation or/and deformation.

The lamination configurations from FIGS. 1A and 3 have been comparatively tested, and inspected. Each comparative test was repeated with a different adhesive to demonstrate that the lamination configuration was responsible for the improved wheel edging performance, rather than the choice of adhesive. In other words, the double adhesive test established that improved edging results from mechanical factors, rather then the chemistry of the adhesive.

Individual Tests

The configuration of FIG. 1A was tested with a TAC film 10a thickness of 40 microns and a pressure sensitive adhesive layer 10g sold under the tradename 3M 8146-1 PSA thickness of 25 microns. After edging, the lens 10m presents lots of defects. The new mechanical lamination configuration according to the invention of FIG. 3 was tested with the same materials. However, the TAC film 34a thickness was 190 microns and the adhesive 34g thickness was 25 microns. After edging, no defects are observable in the lens 34m.

The configuration of FIG. 1A was tested with a TAC film 10a thickness of 40 microns and a PSA layer 10g sold under the tradename Nitto CS962X thickness of 25 microns. After edging the lens 10m presents lots of defects. The new mechanical configuration according to the invention of FIG. 3 was tested with the same materials. However, the TAC film 34a thickness was 190 microns and the adhesive 34g thickness was 25 microns. After edging, no defects are present or tow deformation in the lens 34m. It is readily apparent that the two new mechanical configurations which provided a 190 micron film and 25 micron thick adhesive provided very low and acceptable deformations after edging.

A set of test was performed wherein the Nitto and 3M adhesive, respectively, were applied in a constant 50 micron thickness. The TAC film was then varied in thickness from 40 microns to 190 microns. The test results show that the TAC film thickness parameter is extremely important. The deformations are lower if we increase TAC thickness up until 190 microns. This is true for two different PSA adhesives (Nitto 9622 and 3M 8146-2). Accordingly, when adhesive thickness is constant, there is a significant consistent improvement in edging performance corresponding to increasing TAC thickness. The mechanical configuration has a greater effect on edging performance than the adhesive chemistry. The test demonstrates that any suitable adhesive will provide a laminated lens with improved wheel edging performance when the external film TAC has a thickness in the range of 150 microns to 300 microns inclusive and in particular when it is about 190 microns thick.

The mechanical configuration has a greater effect on wheel edging performance when a thick film is used and this mechanical performance is enhanced when this thick external film is used in combination with a thick adhesive layer. Good results are obtained when the thick film is within a range of 190 microns, for example, 150 to 300 microns inclusive and when the thick glue layer is within a range of 50 microns, for example, 25 to 50 microns inclusive.

In this last test, the 80 micron TAC film is hard coated and glued to the lens. The PSA adhesive is then varied in thickness from 25 microns to 50 microns. The addition of the hard coating gives slightly better results when the adhesive is only 25 microns thick. However, the addition of the hard coating provides lower deformation when the adhesive is 50 microns thick.

When comparing the non-coated test to the coated test, one draws the conclusion that coating the film is totally compatible with the mechanical configuration proposed in this application. Therefore, any laminated lens made according to the invention can be coated. Such coatings include protective coatings, hard-coat, anti-reflective (AR) coating, photochromic coating, tinted coatings, anti-fog coatings or anti-smudge coatings. Alternately, photochromic dyes and tints may be incorporated into the film and then covered in a hard-coat or protective coat.

Since special adhesive chemistry is not required, the lens used with the inventive mechanical configuration of the invention can be made of any type of optical substrate material. For example, the lens can be manufactured by an edge-gated injection molding process or a casting process. In addition the lens can be made from any optical grade material, for example, thermoplastic or thermoset materials. Since the invention is generic with respect to its application process, it can be used with all types of plano or ophthalmic lenses, semi-finished or finished lenses, and can be applied to either the front side or back side lenses. Any type of optical adhesive and application method may be used with the inventive concepts. For example, PSA, hot melt adhesive, latex, single adhesive layers, multi-adhesive layer systems. The adhesives may be applied by any suitable method including lamination, spraying, spin coating, dip coating. The broad range of materials, lens types, and coatings described may be used with both single film and film layered structure laminated lenses according to the invention.

This innovation can be used with any kind of simple or single film for ophthalmic lens applications. The invention is especially effective for film laminated lens applications where film separation is an issue during wheel edging. This innovation improves film edging performance on any kind of wheel edger.

In the above simple film examples, TAC film represents any single film and forms the experimental basis for film layered structure lamination testing, especially when the film layered structure is a tri-layer structure. Indeed one interesting application of the invention is to provide a final ophthalmic lens with light-polarizing function. To this end, the film layered structure may comprise a polyvinyl alcohol based layer (PVA) sandwiched between two identical or different material protecting films selected from, for example, TAC (cellulose triacetate), CAB (cellulose acetate butyrate), PC (polycarbonate), PET (poly(ethylene terephthalate)), PMMA (poly(methylmethacrylate), TPU (urethane polymer), COC (cyclo olefin copolymer) and Polyimides. FIG. 2 and FIG. 4 illustrate a PVA film laminated between the TAC layers, so that these latter act as protecting layers on both sides of the PVA layer. The external film is a TAC layer.

Different from the single film laminated lens where the edging weakness or film delamination area is between the film and lens, for multi-layer film laminated lens, the edging weakness or film delamination area could be within the multi film layers or between the lens and the multilayer film, such as between TAC and PVA. Therefore, there is a need to improve the edging performance for multi-layer structure films with the same principle as single film laminated lens.

Film Layered Structure Laminate with Improved Edging Performance

Building on the knowledge gained by the simple, single film tests, complex, film layered structures were tested next. By way of example, a polarizing structure was used which contains three films that are bound together to form the film layered structure. An intermediate adhesive layer is deposited between the films. More particularly, a TAC-PVA-TAC polarizing tri-layer structure was laminated onto the lens by a tri-layer latex-HMA-latex adhesive system. The polarizing structure was a commercial polar structure available from Onbitt. The film layered structure 80w is laminated to lens 80s with a thin adhesive layer 80g. In these tests, the adhesive layer 80g consisted of a tri-layer Latex-HMA-Latex adhesive system. Such trilayer adhesive system is described in EP2 496 405 owned by the same applicant as the present invention.

To determine the optimal mechanical configuration for film layered structure, the thickness of the external TAC films and the first and second intermediate adhesive layers were varied. For each newly-produced film layered structure configuration an analysis was performed to assess the number of lenses presenting film separation (inside the structure) compared to the total number of lenses edged.

FIG. 4 represents the testing model. The film layered structure 80w consists of an external TAC film 80a, a first intermediate adhesive layer 80b, a PVA film 80c, a second intermediate adhesive layer 80d and an inner TAC film 80e. In all tests, the PVA film 80c remained at 25-35 microns. The TAC films 80a and 80e, were independently selected from thin 80 micron films and thick 190 micron films. The adhesive layers 80b and 80d were independently selected from thin under 0.5 micron adhesive layers and thick 2.5 micron adhesive layers. The polarizing structure glued onto optical lenses with an additional adhesive layer 80g. The laminated lenses were trimmed with standard edgers. The adhesive level of both thin adhesive layer and thick adhesive layer is about same by peel force.

In the following Table 1 it is clearly showed the edging effects of external TAC film thickness and adhesive thickness. It is surprising that the combination of both thickness (external TAC and intermediate adhesives) bring the best results on edging. Neither external TAC thickness alone nor adhesive thickness alone is sufficient to solve this film separation issue during wheel edging. We can see that the main effect is due to the external TAC thickness.

TABLE 1

| | | FILM |
|---|---|---|
| | | SEPARATION ON |
| TAC THICKNESS | ADHESIVE THICKNESS | EDGING |
| Two Thin (80 μm) | Thin (<0.5 μm) intermediate | 100% |
| TAC 80a, 80e | adhesive layer 80b, 80d | |
| Two Thick | Thin (<0.5 μm) intermediate | 20% |
| (190 μm) | adhesive layer 80b, 80d | |
| TAC 80a, 80e | | |
| Thick (190 μm) | Thin (<0.5 μm) intermediate | 20% |
| 80a and Thin | adhesive layer 80b, 80d | |
| (80 μm) 80e | | |
| Two Thin (80 μm) | Thick (~2.5 μm) intermediate | 60% |
| TAC 80a, 80e | adhesive layer 80b, 80d | |
| Thick (190 μm) | Thick (~2.5 μm) intermediate | 0% |
| 80a and Thin | adhesive layer 80b, 80d | |
| (80 um) 80e | | |

Based on the single film testing, one would have expected that improved edging performance would result from a thick adhesive layer 80g and a thick adjacent film layer 80e. Surprisingly, in film layered structure the external film layer 80a in combination with thicker intermediate adhesive layer 80b, 80d has the greatest impact on reducing delamination. Having a thin internal film layer 80e has no impact on delamination as seen from the last line in Table 1.

This invention is useful for single film or film layered structure laminated lens applications where a film separation is an issue during wheel edging, this innovation is a very good way to improve film edging ability on any kind of wheel edgers. The base optical lens could be made of a material classically used in optics and ophthalmology. By way of information but not limitation, the materials are chosen from among the polycarbonates; polyamides; polyimides; polysulfones; copolymers of polyethylene there phthalate and polycarbonate; polyolefins, namely polynorbornenes; polymers and copolymers of diethylene glycol bis(allylcarbonate); (meth)acrylic polymers and copolymers; namely (meth)acrylic polymers and copolymers derived from bisphenol-A; thio(meth)acrylic polymers and copolymers; urethane and thiourethane polymers and copolymers; epoxy polymers and copolymers; and epi sulfide polymers and copolymers.

The single film or film layered structure contributes an optical or performance function to the optical base lens. The type of functionality can be a function protecting against photodegradation or photo-oxidation, an anti-shock function, an anti-radiation function, an anti-reflection function, a polarizing function, a color filtration function, a photochromic function, an antistatic function, an anti-contamination function, a function applied by a pixel or microstructured architecture. In a preferred embodiment of the invention, a polarizing structure is adhered to an optical base lens to provide a polarized lens.

The invention is useful for laminating the single film or film layered structure to either the convex or the concave side of optical base lenses, for example ophthalmic lenses. The lenses may be sunglasses, plano lenses, visors, or prescription (Rx) lenses. Such lenses may include finished lenses (F), semi-finished lenses (SF), progressive addition lenses (PAL), multifocal lenses, unifocal lenses and afocal lenses. The optical base lens may be clear, tinted or dyed.

Having described preferred embodiments for adhesive, films, film layered structures, laminated lenses and processes for manufacturing same (which are intended to be illustrative and not limiting), it is noted that modifications and variations can be made by persons skilled in the art in light of the above teachings. For example, other equivalent elements can be included in the laminated lens product depending on the intended application. In addition, other lens laminating steps, or steps in different orders may be carried out to achieve similar results. It is therefore to be understood that changes may be made in the particular embodiments of the invention disclosed which are within the scope and spirit of the invention as outlined by the appended claims.

1.-14. (canceled)

15. A laminated optical lens having an edging-optimized laminar configuration comprising:
an optical base lens;
a film layered structure including an external film furthest from said lens; and
an adhesive layered structure disposed between said film layered structure and said optical base lens so as to permanently retain said film layered structure on the surface of the optical base lens,
wherein said external film has a thickness of at least 100 μm.

16. The laminated optical lens of claim 15, wherein said external film has a thickness in a range of 150 microns to 300 microns inclusive.

17. The laminated optical lens of claim 15, wherein the adhesive layered structure comprises at least one layer of a pressure sensitive adhesive of optical quality, having a thickness in a range of 5 microns to 100 microns inclusive.

18. The laminated optical lens of claim 17, wherein the pressure sensitive adhesive of optical quality has a thickness in a range of 25 microns to 50 microns inclusive.

19. The laminated optical lens of claim 15, wherein the adhesive layered structure comprises a tri-layer adhesive structure having a thickness in a range of 5 microns to 16 microns inclusive, said tri-layer adhesive structure comprising two layers of latex adhesive and one layer of hot melt adhesive sandwiched between the two layers of latex.

20. The laminated optical lens of claim 15, wherein the film layered structure comprises:
two or more films including the external film, and a proximal film which is in contact with the adhesive layered structure; and
one or more intermediate adhesive layers disposed between the films, said intermediate adhesive layer having a thickness of above 0.5 microns.

21. The laminated optical lens of claim 20, wherein the film layered structure comprises an intermediate film sandwiched between the external film and the intermediate adhesive layer has a thickness of in a range of 1.0 microns to 5.0 microns inclusive.

22. The laminated optical lens of claim 20, wherein the intermediate film is a light-polarizing polyvinyl alcohol-based layer (PVA).

23. The laminated optical lens of claim 22, wherein the external and proximal films independently comprise TAC (cellulose triacetate), CAB (cellulose acetate butyrate), PC (polycarbonate), PET (poly(ethylene terephthalate)), PMMA (poly(methylmethacrylate), TPU (urethane polymer), COC (cyclo olefin copolymer) or a polyimide.

24. The laminated optical lens of claim 15, wherein the said external film is a triacetyl cellulose-base layer (TAC), said TAC layer having a thickness of at least 100 μm.

25. The laminated optical lens of claim 24, wherein the TAC layer has a thickness in a range of 150 microns to 300 microns inclusive.

26. The laminated optical lens of claim 17, wherein the film layered structure comprises one triacetyl cellulose-base layer (TAC) which is in contact with the layer of a pressure sensitive adhesive.

27. A method for manufacturing a laminated lens comprising the steps of forming an edging-optimized laminated lens by:
providing an optical base lens;
providing an adhesive layered structure;
providing a film layered structure including an external film; and
laminating said film layered structure to the optical base element, with said adhesive layered structure disposed between said film layered structure and said optical base lens so as to retain permanently said film layered structure on the surface of said optical base lens;
wherein said external film has a thickness of at least 100 μm.

28. The method of claim 27, wherein the external film has a thickness in a range of 150 microns to 300 microns inclusive.

29. The method of claim 27, wherein the adhesive layered structure comprises at least one layer of a pressure sensitive adhesive of optical quality, having a thickness in a range of 5 microns to 100 microns inclusive.

30. The method of claim 27, wherein the film layered structure comprises one triacetyl cellulose-base layer (TAC) which is in contact with the layer of a pressure sensitive adhesive.

31. The method of claim 27, wherein the adhesive layered structure comprises a tri-layer adhesive structure having a thickness in a range of 5 microns to 16 microns, said tri-layer adhesive structure comprising two layers of latex adhesive and one layer of hot melt adhesive sandwiched between the two layers of latex.

32. The method of claim 27, wherein the film layered structure comprises:
two or more films including the external film, and a proximal film which is in contact with the adhesive layered structure; and
one or more intermediate adhesive layers disposed between the films, said intermediate adhesive layer having a thickness of above 0.5 microns.

33. The method of claim 32, wherein the film layered structure further comprises an intermediate film sandwiched between the external film and the proximal film comprising a light-polarizing polyvinyl alcohol-based layer (PVA), and wherein the external and proximal films independently comprise TAC (cellulose triacetate), CAB (cellulose acetate butyrate), PC (polycarbonate), PET (poly(ethylene terephthalate)), PMMA (poly(methylmethacrylate), TPU (urethane polymer), COC (cyclo olefin copolymer) or a polyimide.

34. The method of claim 27, wherein the external film is a triacetyl cellulose-base layer (TAC), said TAC layer having a thickness of at least 100 μm.
